(19) United States
(12) Patent Application Publication
(10) Pub. No.: US 2007/0178273 A1
(43) Pub. Date: Aug. 2, 2007

(54) Embossing loop materials

(76) Inventors: George A. Provost, Litchfield, NH (US); James R. Barker, Francestown, NH (US)

Correspondence Address: FISH & RICHARDSON PC, P.O. BOX 1022, MINNEAPOLIS, MN, 55440-1022, US

(21) Appl. No.: 11/345,838

(22) Filed: Feb. 1, 2006

(51) Int. Cl. B32B 33/00; B32B 3/02; B32B 3/06

(52) U.S. Cl. 428/89; 428/88; 428/92; 428/99

(57) ABSTRACT

A loop fastener product is provided including a generally planar nonwoven base of fibers, and a field of loop structures extending from the generally planar nonwoven base of fibers. The field includes (a) generally parallel engageable bands in which the loop structures are exposed on a front surface of the nonwoven base for releasable engagement by hooks; and (b) generally parallel bond area bands, separating the bands of loop structures, in which a major proportion of the loop structures are bonded together in the plane of the nonwoven base. Methods of forming loop fastener products are also provided.

### TECHNICAL FIELD

This invention relates to methods of making products having loops, such as for hook-and-loop fastening, and products produced by such methods.

### BACKGROUND

In the production of woven and non-woven materials, it is common to form the material as a continuous web that is subsequently spooled. In woven and knit loop materials, loop-forming filaments or yams are included in the structure of a fabric to form upstanding loops for engaging hooks. As hook-and-loop fasteners find broader ranges of application, especially in inexpensive, disposable products, some forms of non-woven materials have been employed as loop material to reduce the cost and weight of the loop product while providing adequate closure performance in terms of peel and shear strength. Nevertheless, cost of the loop component has remained a major factor limiting the extent of use of hook and loop fasteners.

To adequately perform as a loop component for touch fastening, the loops of the material must be exposed for engagement with mating hooks. Unfortunately, compression of loop material during packaging and spooling tends to flatten standing loops. In the case of diapers, for instance, it is desirable that the loops of the loop material provided for diaper closure not remain flattened after the diaper is unfolded and ready for use.

Also, the loops generally should be secured to the web sufficiently strongly so that the loop material provides a desired degree of peel strength when the fastener is disengaged, and so that the loop material retains is usefulness over a desired number of closure cycles. The desired peel and shear strength and number of closure cycles will depend on the application in which the fastener is used.

The loop component should also have sufficient strength, tear-resistance, integrity, and secure anchoring of the loops so that the loop component can withstand forces it will encounter during use, including dynamic peel forces and static forces of shear and tension.

### SUMMARY

In one aspect, the invention features a loop fastener product that includes a generally planar nonwoven base of fibers, and a field of loop structures extending from the generally planar nonwoven base of fibers. The field of loop structures includes (a) generally parallel engageable bands in which the loop structures are exposed on a front surface of the nonwoven base for releasable engagement by hooks; and (b) generally parallel bond area bands, separating the bands of loop structures, in which a major proportion of the loop structures are bonded together in the plane of the nonwoven base.

Some implementations include one or more of the following features. The product also includes a substrate disposed within the nonwoven base. The fibers extend through a front surface of the substrate to form the loop structures. The fibers are anchored at a back surface of the substrate. In some cases, the fibers may include bicomponent fibers, in which case the fibers may be bonded to each other and/or anchored at the back surface of the substrate by material of sheaths of the bicomponent fibers.

In some implementations, the areas of the field of loop structures may have the following dimensions. The spacing between adjacent bond area bands, measured from the center of one band to the center of an adjacent band, is about 3 to about 6 millimeters. The thickness of each bond area band, measured from one edge of the bond area band to the other, is about 1 to about 1.5 millimeter. The bond area bands cover about 15 to 50 percent of the total area of the product.

In some cases, the bond area bands are longitudinally continuous.

In another aspect, the invention features a method of forming a loop fastener product, including (a) forming a field of loop structures extending upwardly from a front surface of a generally planar nonwoven base and exposed for releasable engagement with hooks; and then (b) embossing the front surface of the nonwoven base to bond the loop structures to each other in generally parallel bond area bands, in which the loop structures extend generally in the plane of the nonwoven base and are substantially unavailable for engagement, while leaving engageable bands, between the bond area bands, in which loop structures remain available for engagement.

Some implementations include one or more of the following features. The forming step includes needling a plurality of staple fibers through a carrier sheet. The forming step further includes applying heat and pressure to the needled carrier, in a manner which fuses fibers to a back surface of the carrier, thereby forming a composite. The method includes, while applying the heat and pressure, protecting the loop structures on the front side of the substrate from application of the pressure. The fibers include bicomponent core-sheath fibers with sheaths of material having a lower melting point than their cores. The carrier sheet includes a polymer film. The embossing step comprises passing the nonwoven base through a nip such that the front surface contacts an embossing roll having a plurality of embossing ribs. The embossing ribs extend axially. The embossing step includes forming the bond area bands in a cross-machine direction. The embossing step is conducted at a nip pressure of less than about 80 pli (pounds/linear inch), e.g., about 40 to about 60 pli.

Various aspects of the invention can provide an inexpensive, lightweight loop product which can effectively engage and retain hooks, such as in hook-and-loop fasteners. The loop product can be particularly useful in combination with extremely small, inexpensive molded hooks as fasteners for disposable products, such as diapers, medical devices or packaging. We have found, for instance, that the structure of the material, described below in more detail, helps to prevent permanent flattening of the loops and provides some advantageous crush resistance. Moreover, some loop products have a soft hand and good drapability, further enhancing their suitability for use in products such as diapers and other garments.

The loops are generally well anchored, giving the fastener relatively good peel strength and re-usability, and the loop product has good tear resistance. The balance of properties of the loop material (e.g., cost, weight, strength and durability) can be easily adjusted, as will be discussed below.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a diagrammatic view of a process for forming loop material.

FIGS. 2A-2D are diagrammatic side views of stages of a needing step of the process of FIG. 1. FIG. 2E is a diagrammatic side view showing an elliptical path that may be followed by the needle during needling.

FIG. 3 is an enlarged diagrammatic view of a lamination nip through which the loop material passes during the process of FIG. 1.

FIG. 4 is a highly enlarged diagrammatic view of a loop structure formed by needling with fork needles through film.

FIG. 4A is an enlarged photograph of a rolled edge of a loop product formed by needling with fork needles through film, showing several discrete loop structures.

FIG. 4B is a highly enlarged photograph of one of the loop structures shown in FIG. 4A.

FIG. 4C illustrates a loop structure formed by needling with crown needles through polyester film.

FIG. 5 is a diagrammatic view showing an alternative lamination step utilizing a powder-form binder.

FIG. 6 is an enlarged photograph, taken from above, of a loop material having an embossed pattern on its loop-carrying surface.

FIG. 6A is a highly enlarged photograph of a portion of the area shown in FIG. 6.

FIG. 7 is an enlarged photograph, taken from the side, showing fibers of the loop material of FIG. 6 bonded to each other along bond lanes.

FIG. 7A is a highly enlarged photograph of an area of the loop material shown in FIG. 7.

FIG. 8 is a partial perspective view of a loop product having a plurality of generally parallel bond lanes extending in the cross-machine direction.

FIG. 8A is a highly enlarged side view of the loop product shown in FIG. 8.

FIG. 8B is an enlarged detail view of area B in FIG. 8A.

FIG. 8C is an enlarged detail view of area C in FIG. 8B.

Like reference symbols in the various drawings indicate like elements.

### DETAILED DESCRIPTION

Descriptions of loop products will follow a description of some methods of making loop products.

Generally, the loop products described herein are produced by a method involving the following steps: (a) carding staple fibers to form a carded web; (b) needling fibers of the carded web through a carrier to form loop structures; (c) laminating fibers to a back surface of the carrier; and (d) embossing bond lines onto the loop-carrying front surface of the product. While the focus of this application is on the embossing step, for clarity these steps will be discussed below in the order in which they are performed. Thus, we will initially describe how the loop product is formed up to the embossing step, and then will describe the embossing step in detail.

These processes produce loop products that include a plurality of the loop structures that are formed by the needling step, extending upwardly from a generally planar carrier sheet. As will be discussed in detail in the “Loop Products” section below, the loop products include a plurality of bond lanes, in which the loop structures have been laid over generally parallel to the surface of the carrier sheet, and unbonded areas in which the loop structures stand upright.

Carding and Cross-Lapping

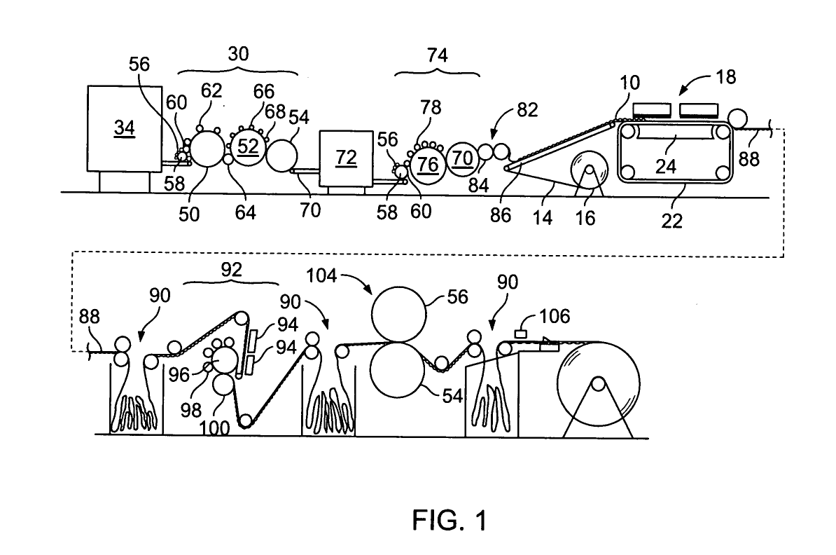

FIG. 1 illustrates a machine and process for producing an inexpensive touch fastener loop product. Beginning at the upper left end of FIG. 1, a carded and cross-lapped layer of fibers 10 is created by two carding stages with intermediate cross-lapping. In some cases, the intermediate cross-lapping step is not included, for instance if the fibers are uniformly distributed prior to or during the previous carding step.

Weighed portions of staple fibers of different types are fed to the first carding station 30 by a card feeder 34. Card station 30 includes a 36-inch breast roll 50, a 60-inch breaker main 52, and a 50-inch breaker doffer 54. The first card feedroll drive includes 3-inch feedrolls 56 and a 3-inch cleaning roll on a 13-inch lickerin roll 58. An 8-inch angle stripper 60 transfers the fiber to breast roll 50. There are three 8-inch worker roll sets 62 on the breast roll, and a 16-inch breast doffer 64 feeds breaker main 52, against which seven 8-inch worker sets 66 and a flycatcher 68 run. The carded fibers are combed onto a conveyer 70 that transfers the fiber layer into a cross-lapper 72. Before cross-lapping, the different fiber types, corresponding to the fibrous balls fed to carding station 30 from the different feed bins, may not be uniformly distributed. Cross-lapping, which normally involves a 90-degree reorientation of line direction, overlaps the fiber layer upon itself and is adjustable to establish the width of fiber layer fed into the second carding station 74. In this example, the cross-lapper output width is set to approximately equal the width of the carrier into which the fibers will be needled. Cross-lapper 72 may have a lapper apron that traverses a floor apron in a reciprocating motion. The cross-lapper lays carded webs of, for example, about 80 inches (1.5 meters) width and about one-half inch (1.3 centimeters) thickness on the floor apron, to build up several layers of criss-crossed web to form a layer of, for instance, about 80 inches (1.5 meters) in width and about 4 inches (10 centimeters) in thickness, comprising four double layers of carded web. During carding, the fibers are separated and combed into a cloth-like mat consisting primarily of parallel fibers. With nearly all of its fibers extending in the carding direction, the mat has some strength when pulled in the carding direction but almost no strength when pulled in the carding cross direction, as cross direction strength results only from a few entanglements between fibers. During cross-lapping, the carded fiber mat is laid in an overlapping zigzag pattern, creating a mat 10 of multiple layers of alternating diagonal fibers. The diagonal layers, which extend in the carding cross direction, extend more across the apron than they extend along its length.

Cross-lapping the web before the second carding process provides several tangible benefits. For example, it enhances the blending of the fiber composition during the second carding stage. It also allows for relatively easy adjustment of web width and basis weight, simply by changing cross-lapping parameters.

Second carding station 74 takes the cross-lapped mat of fibers and cards them a second time. The feedroll drive consists of two 3-inch feed rolls and a 3-inch cleaning roll on a 13-inch lickerin 58, feeding a 60-inch main roll 76 through an 8-inch angle stripper 60. The fibers are worked by six 8-inch worker rolls 78, the last five of which are paired with 3-inch strippers. A 50-inch finisher doffer 80 transfers the carded web to a condenser 82 having two 8-inch condenser rolls 84, from which the web is combed onto a carrier sheet 14 fed from spool 16. The condenser increases the basis weight of the web from about 0.7 osy (ounce per square yard) to about 1.0 osy, and reduces the orientation of the fibers to remove directionality in the strength or other properties of the finished product.

Needling Through a Carrier

The carrier sheet 14, such as polymer film or paper, may be supplied as a single continuous length, or as multiple, parallel strips. For particularly wide webs, it may be necessary or cost effective to introduce two or more parallel sheets, either adjacent or slightly overlapping. The parallel sheets may be unconnected or joined along a mutual edge. The carded, uniformly blended layer of fibers from condenser 82 is carried up conveyor 86 on carrier sheet 14 and into needling station 18. As the fiber layer enters the needling station, it has no stability other than what may have been imparted by carding and cross-lapping. In other words, the fibers are not pre-needled or felted prior to needling into the carrier sheet. In this state, the fiber layer is not suitable for spooling or accumulating prior to entering the needling station.

In needling station 18, the carrier sheet 14 and fiber are needle-punched from the fiber side. The needles are guided through a stripping plate above the fibers, and draw fibers through the carrier sheet 14 to form loops on the opposite side. During needling, the carrier sheet is supported on a bed of pins or bristles extending from a driven support belt or brush apron 22 that moves with the carrier sheet through the needling station. Alternatively, carrier sheet 14 can be supported on a screen or by a standard stitching plate (not shown). Reaction pressure during needling is provided by a stationary reaction plate 24 underlying apron 22. In this example, needling station 18 needles the fiber-covered carrier sheet 14 with an overall penetration density of about 80 to 160 punches per square centimeter. At this needling density and with a carrier sheet of a polypropylene film of a thickness of about 0.0005 inch (0.013 millimeter) to about 0.0015 inch (0.039 millimeter), we have found that 36 to 42 gauge forked tufting needles, e.g., 38 to 40 gauge needles, were small enough to not obliterate the film. Thus, needling left sufficient film interconnectivity that the film continued to exhibit some dimensional stability within its plane. With the same parameters, larger 30 gauge needles essentially segmented the film into small, discrete pieces entangled within the fibers. During needling, the thickness of the carded fiber layer only decreases by about half, as compared with felting processes in which the fiber layer thickness decreases by one or more orders of magnitude. As fiber basis weight decreases, needling density may need to be increased.

The needling station 18 may be a “structuring loom” configured to subject the fibers and carrier web to a random velouring process. Thus, the needles penetrate a moving bed of bristles arranged in an array (brush apron 22). The brush apron may have a bristle density of about 2000 to 3000 bristles per square inch (310 to 465 bristles per square centimeter), e.g., about 2570 bristles per square inch (400 per square centimeter). The bristles are each about 0.018 inch (0.46 millimeter) in diameter and about 20 millimeters long, and are preferably straight. The bristles may be formed of any suitable material, for example 6/12 nylon. Suitable brushes may be purchased from Stratosphere, Inc., a division of Howard Brush Co., and retrofitted onto DILO and other random velouring looms. Generally, the brush apron moves at the desired line speed.

Alternatively, other types of structuring looms may be used, for example those in which the needles penetrate into a plurality of lamella or lamellar disks.

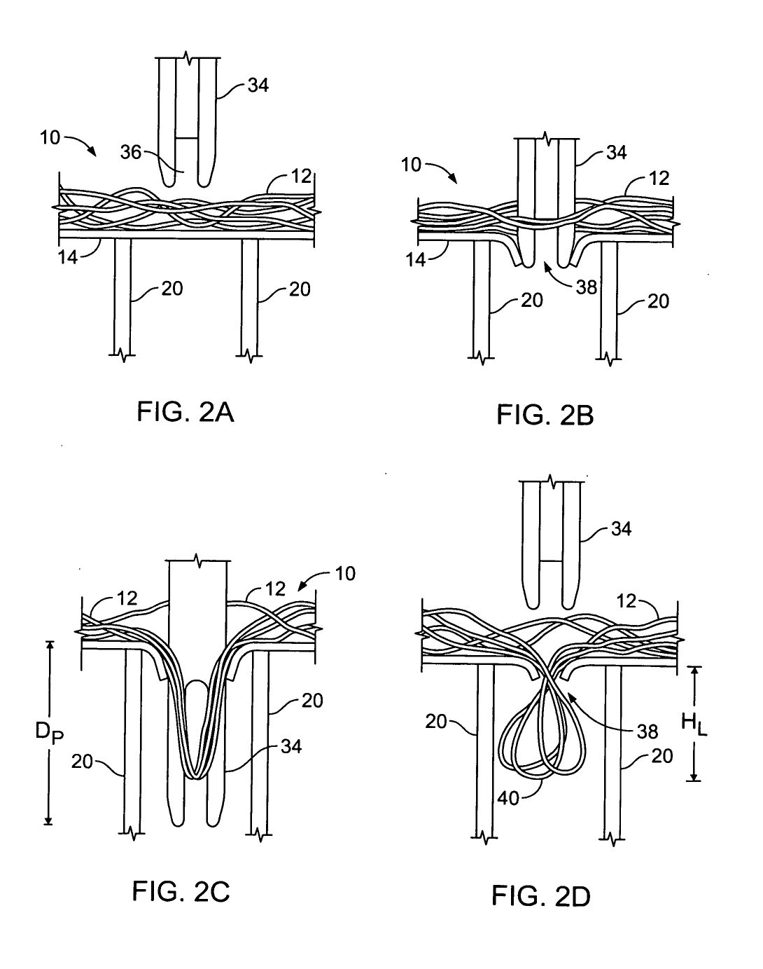

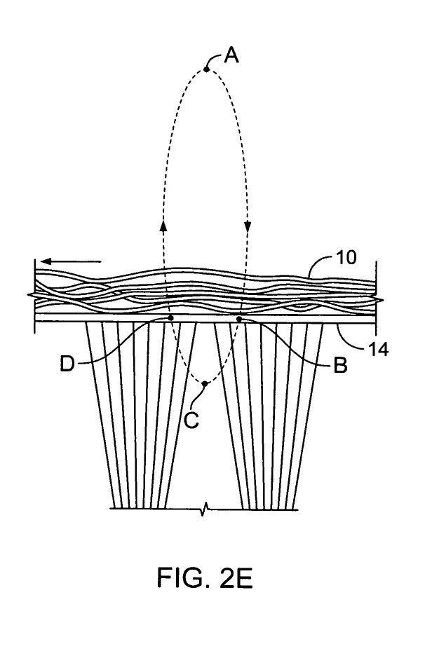

FIGS. 2A through 2D sequentially illustrate the formation of a loop structure by needling. As a forked needle enters the fiber mat 10 (FIG. 2A), some individual fibers 12 will be captured in the cavity 36 in the forked end of the needle. As needle 34 pierces film 14 (FIG. 2B), these captured fibers 12 are drawn with the needle through the hole 38 formed in the film to the other side of the film. As shown, film 14 remains generally supported by bristles 20 through this process, the penetrating needle 34 entering a space between adjacent bristles. Alternatively, film 14 can be supported by a screen or stitching plate (not shown) that defines holes aligned with the needles. As needle 34 continues to penetrate (FIG. 2C), tension is applied to the captured fibers, drawing mat 10 down against film 14. In this example, a total penetration depth “D_{P}” of about 5.0 millimeters, as measured from the entry surface of film 14, was found to provide a well-formed loop structure without overly stretching fibers in the remaining mat. Excessive penetration depth can draw loop-forming fibers from earlier-formed tufts, resulting in a less robust loop field. Penetration depths of 2 and 7 millimeters also worked in this example, although the 5.0 millimeter penetration is presently preferred. When needle 34 is retracted (FIG. 2D), the portions of the captured fibers 12 carried to the opposite side of the carrier web remain in the form of a plurality of individual loops 40 extending from a common trunk 42 trapped in film hole 38. As shown, residual stresses in the film 14 around the hole, acting to try to restore the film to its planar state, can apply a slight pressure to the fibers in the hole, helping to secure the base of the loop structure. The film can also help to resist tension applied to the fiber remaining on the mat side of the film that would tend to pull the loops back through the hole. The final loop formation preferably has an overall height “H_{L}” of about 0.040 to 0.090 inch (1.0 to 2.3 millimeters), for engagement with the size of male fastener elements commonly employed on disposable garments and such.

Advance per stroke is limited due to a number of constraints, including needle deflection and potential needle breakage. Thus, it may be difficult to accommodate increases in line speed and obtain an economical throughput by adjusting the advance per stroke. As a result, the holes pierced by the needles may become elongated, due to the travel of the carrier sheet while the needle is interacting with the carrier sheet (the “dwell time”). This elongation is generally undesirable, as it reduces the amount of support provided to the base of each of the loop structures by the surrounding substrate, and may adversely affect resistance to loop pull-out. Moreover, this elongation will tend to reduce the mechanical integrity of the carrier film due to excessive drafting, i.e., stretching of the film in the machine direction and corresponding shrinkage in the cross-machine direction.

Elongation of the holes may be reduced or eliminated by causing the needles to travel in a generally elliptical path, viewed from the side. This elliptical path is shown schematically in FIG. 2E. Referring to FIG. 2E, each needle begins at a top “dead” position A, travels downward to pierce the film (position B) and, while it remains in the film (from position B through bottom “dead” position C to position D), moves forward in the machine direction. When the needle has traveled upward sufficiently for its tip to have exited the pierced opening (position D), it continues to travel upward, free of the film, while also returning horizontally (opposite to the machine direction) to its normal, rest position (position A), completing the elliptical path. This elliptical path of the needles is accomplished by moving the entire needle board simultaneously in both the horizontal and vertical directions. Needling in this manner is referred to herein as “elliptical needling.” Needling looms that perform this function are available from DILO System Group, Eberbach, Germany, under the tradename “HYPERPUNCH Systems.”

During elliptical needling, the horizontal travel of the needle board is preferably roughly equivalent to the distance that the film advances during the dwell time. The horizontal travel is a function of needle penetration depth, vertical stroke length, carrier film thickness, and advance per stroke. Generally, at a given value of needle penetration and film thickness, horizontal stroke increases with increasing advance per stroke. At a fixed advance per stroke, the horizontal stroke generally increases as depth of penetration and web thickness increases.

For example, for a polypropylene film having a thickness of 0.0005 inch (so thin that it is not taken into account), a loom outfeed of 18.9 m/min, an effective needle density of 15,006 needles/meter, a vertical stroke of 35 mm, a needle penetration of 5.0 mm, and a headspeed of 2,010 strokes/min, the preferred horizontal throw (i.e., the distance between points B and D in FIG. 2E) would be 3.3 mm, resulting in an advance per stroke of 9.4 mm.

Using elliptical needling, it may be possible to obtain line speeds 30 ypm (yards/minute) or mpm (meters/minute) or greater, e.g., 50 ypm or mpm, for example 60 ypm. Such speeds may be obtained with minimal elongation of the holes, for example the length of the holes in the machine direction may be less than 20% greater than the width of the holes in the cross-machine direction, preferably less than 10% greater and in some instances less than 5% greater.

Lamination of Fibers to the Carrier

In the example illustrated, the needled product 88 leaves needling station 18 and brush apron 22 in an unbonded state, and proceeds to a lamination station 92. If the needling step was performed with the carrier sheet supported on a bed of rigid pins, lamination can be performed with the carrier sheet still carried on the bed of pins. Prior to the lamination station, the web passes over a gamma gage (not shown) that provides a rough measure of the mass per unit area of the web. This measurement can be used as feedback to control the upstream carding and cross-lapping operations. The web is stable enough at this stage to be accumulated in an accumulator 90 between the needling and lamination stations. As known in the art, accumulator 90 is followed by a spreading roll (not shown) that spreads and centers the web prior to entering the next process. Prior to lamination, the web may also pass through a coating station (not shown) in which a binder is applied to enhance lamination. In lamination station 92, the web first passes by one or more infrared heaters 94 that preheat the fibers and/or carrier sheet from the side opposite the loops. In products relying on bicomponent fibers for bonding, heaters 94 preheat and soften the sheaths of the bicomponent fibers. In one example, the heater length and line speed are such that the web spends about four seconds in front of the heaters. Just downstream of the heaters is a web temperature sensor (not shown) that provides feedback to the heater control to maintain a desired web exit temperature. For lamination, the heated web is trained about a hot can 96 against which four idler card cloth-covered rolls 98 of five inch (13 centimeters) solid diameter (excluding the card cloth), and a driven, rubber, card cloth-covered roll 100 of 18 inch (46 centimeters) solid diameter, rotate under controlled pressure. The pins of the card cloth rolls 98,100 thus press the web against the surface of hot can 96 at discrete pressure points, bonding the fibers at discrete locations without crushing other fibers, generally between the bond points, that remain exposed and open for engagement by hooks. For many materials, the bonding pressure between the card cloth rolls and the hot can is quite low, in the range of 1-10 pounds per square inch (70-700 grams per square centimeter) or less. The surface of hot can 96 is maintained at a temperature of about 306 degrees Fahrenheit (150 degrees Celsius) for one example employing bicomponent polyester fiber and polypropylene film, to just avoid melting the polypropylene film. The hot can 96 can have a compliant outer surface, or be in the form of a belt. As an alternative to roller nips, a flatbed fabric laminator (not shown) can be employed to apply a controlled lamination pressure for a considerable dwell time. Such flatbed laminators are available from Glenro Inc. in Paterson, N.J. In some applications, the finished loop product is passed through a cooler (not shown) prior to embossing.

The pins extending from card cloth-covered rolls 98,100 are arranged in an array of rows and columns, with a pin density of about 200 and 350 pins per square inch (31 to 54 pins per square centimeter) in a flat state, preferred to be between about 250 to 300 pins per square inch (39 to 47 pins per square centimeter). The pins are each about 0.020 inch (0.5 millimeter) in diameter, and are preferably straight to withstand the pressure required to laminate the web. The pins extend from a backing about 0.25 inch (6.4 millimeters) in thickness. The backing is of two layers of about equal thickness, the lower layer being of fibrous webbing and the upper layer being of rubber. The pins extend about 0.25 inch (6.4 millimeters) from the rubber side of the backing. Because of the curvature of the card cloth rolls, the effective density of the pin tips, where lamination occurs, is lower than that of the pins with the card cloth in a flat state. A flat state pin density of 200 to 350 pins per square inch (31 to 54 pins per square centimeter) equates to an effective pin density of only 22 to 38 pins per square centimeter on idler rolls 98, and 28 to 49 pins per square centimeter on driven rubber roll 100. In most cases, it is preferable that the pins not penetrate the carrier sheet during bonding, but that each pin provide sufficient support to form a robust bond point between the fibers. In a non-continuous production method, such as for preparing discrete patches of loop material, a piece of carrier sheet 14 and a section of fiber mat 12 may be layered upon a single card cloth, such as are employed for carding webs, for needling and subsequent bonding, prior to removal from the card cloth.

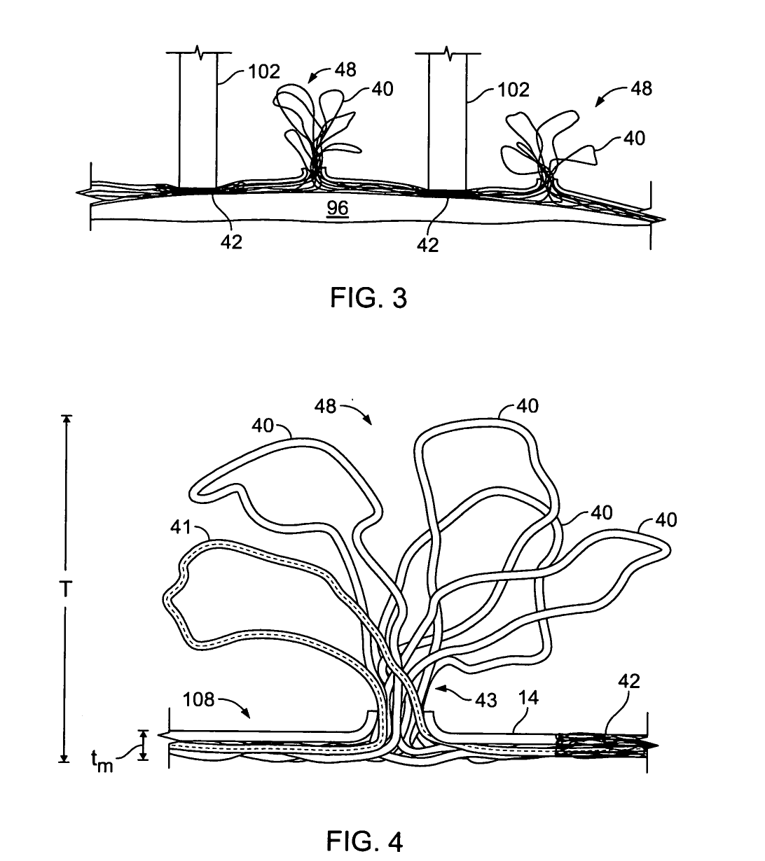

FIG. 3 is an enlarged view of the nip between hot can 96 and one of the card cloth rolls. As discussed above, due to the curvature of the card cloth rolls, their pins 102 splay outward, such that the effective pin density at the hot can is lower than that of the card cloth in a planar state. The pins contact the carrier sheet (or its remnants, depending on needling density) and fuse underlying fibers to each other and/or to material of the carrier sheet, forming a rather solid mass 42 of fused material in the vicinity of the pin tip, and a penumbral area of fused but distinct fibers surrounding each pin. The laminating parameters can be varied to cause these penumbral, partially fused areas to be overlapped if desired, creating a very strong, dimensionally stable web of fused fibers across the non-working side of the loop product that is still sufficiently flexible for many uses.

Alternatively, the web can be laminated such that the penumbral areas are distinct and separate, creating a looser web. For most applications the fibers should not be continuously fused into a solid mass across the back of the product, in order to retain a good hand and working flexibility. The number of discrete fused areas per unit area of the bonded web is such that staple fibers with portions extending through holes to form engageable loops 40 that have other portions, such as their ends, secured in one or more of such fused areas 42, such that the fused areas are primarily involved in anchoring the loop fibers against pullout from hook loads. Whether the welds are discrete points or an interconnected grid, this further secures the fibers, helping to strengthen the loop structures 48. The laminating occurs while the loop structures 48 are safely disposed between pins 102, such that no pressure is applied to crush the loops during bonding. Protecting the loop structures during lamination significantly improves the performance of the material as a touch fastener, as the loop structures remain extended from the base for hook engagement.

If desired, a backing sheet (not shown) can be introduced between the hot can and the needled web, such that the backing sheet is laminated over the back surface of the loop product while the fibers are bonded under pressure from the pins of apron 22.

Embossing

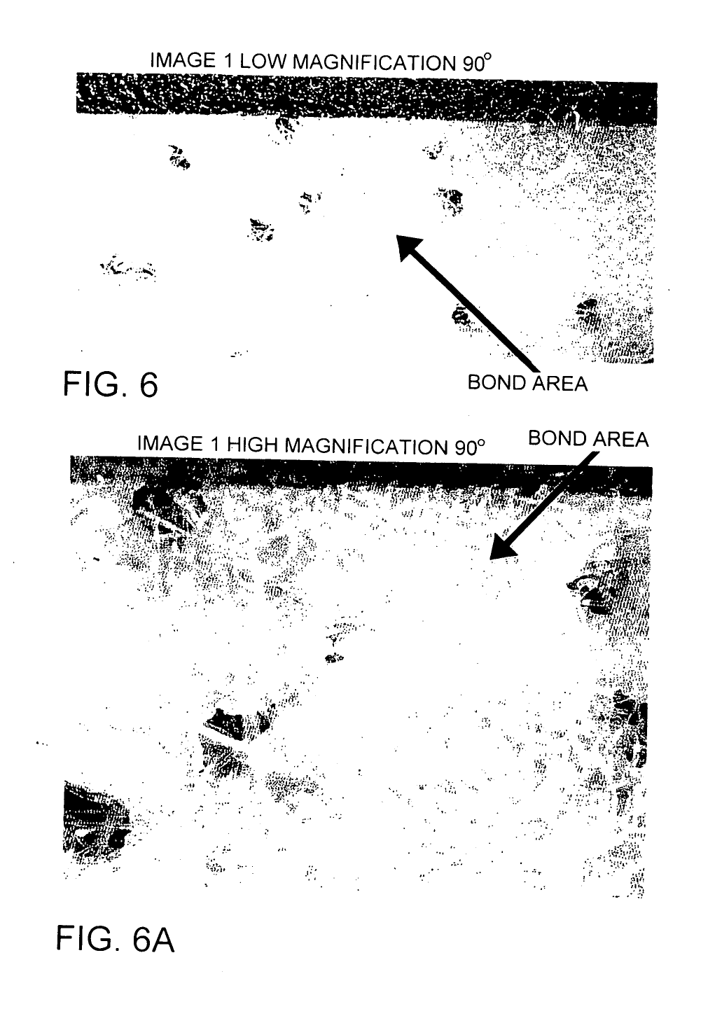

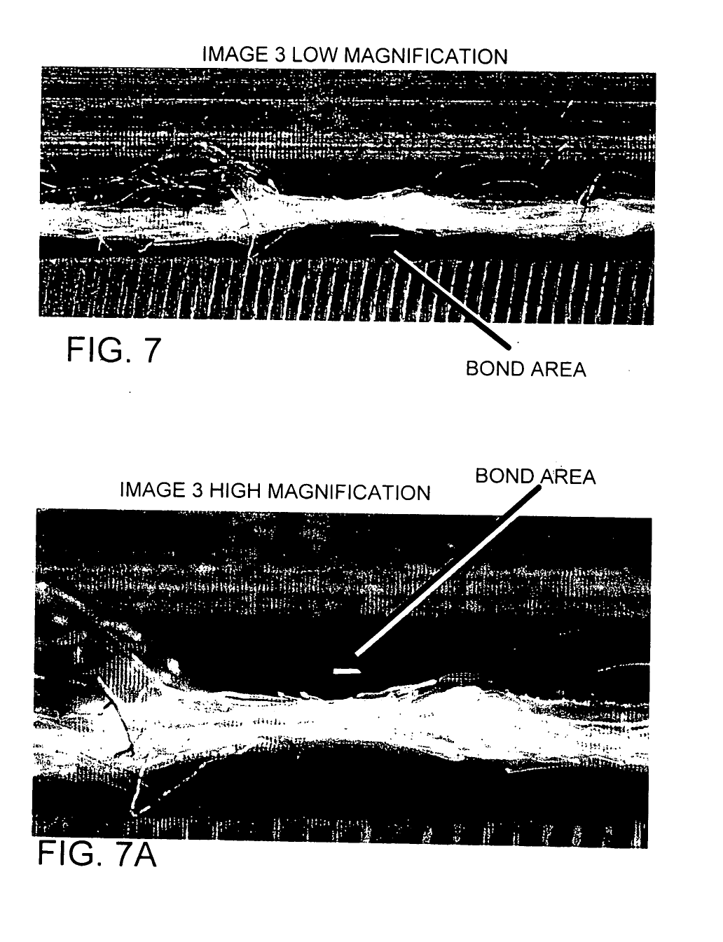

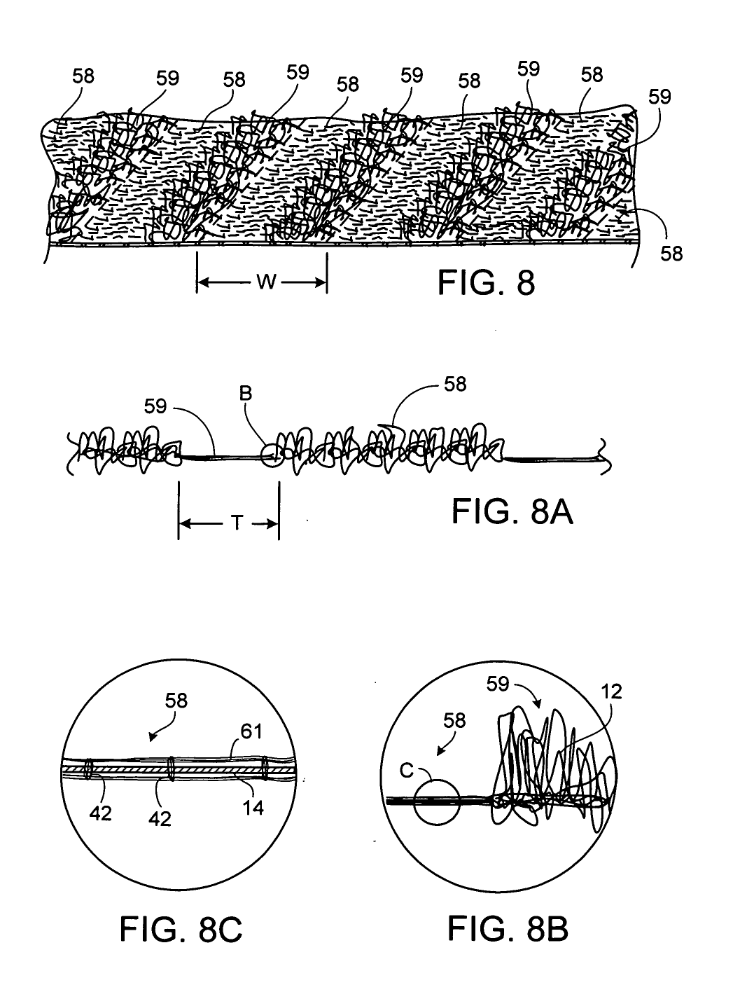

Referring back to FIG. 1, from lamination station 92 the laminated web moves through another accumulator 90 to an embossing station 104, where a desired pattern of locally raised regions is embossed into the web between two counter-rotating embossing rolls. In some cases, the web may move directly from the laminator to the embossing station, without accumulation, so as to take advantage of any latent temperature increase caused by lamination. The loop side of the bonded loop product is embossed prior to spooling. In this example the loop product is passed through a nip between a driven embossing roll 54 and a backup roll 56. The embossing roll 54 has a plurality of raised ribs, extending in the cross-machine direction, that permanently crush the loop formations against the carrier sheet, and fuse together many of the loops in those areas. As shown in FIGS. 6-6A and 7-7A, and as will be discussed further below, embossing tends to cause the loops to lay over, generally parallel to the surface of the carrier sheet, and to be fused together in this position. As is apparent in FIGS. 7-7A, and as is shown diagrammatically in FIG. 8C, the crushed loops generally do not fuse to the carrier sheet;

rather, they fuse predominantly to one another. It is believed that a small clearance exists between the carrier sheet 14 and the fused fibers 61, as illustrated in FIG. 8C. As is also apparent in FIGS. 6-7A, in the embossed areas, referred to herein as “bond lanes,” very few, if any, loops remain available for engagement. While not wishing to be bound by theory, the inventors believe that the lane of loops fused to each other, in a plane generally parallel to the plane of the web, acts as a “chain stitch” extending in the cross-machine direction, supporting loads that are applied to the loop material during use. This theory is based on the observation that the tear strength and other physical properties of the loop material are dramatically increased when the loop material is embossed with bond lanes, relative to the tear strength observed with other embossing patterns such as a hexagonal “quilted” pattern. The tear strength and shear strength of the loop material with bond lanes is also generally higher than the strengths of the same loop material with no embossing.

Embossing parameters will depend upon the materials used. However, generally the embossing pressure is relatively low, e.g., less than 80 pli (pounds/linear inch), preferably from about 40 to about 60 pli. The embossing pressure should generally be sufficiently high so that a majority of the fibers are fused together in the bond lanes, while being low enough so that the carrier sheet is not damaged during the embossing step. Preferably, the embossing pressure is selected so that substantially all of the fibers are fused in the bond lanes.

The embossing roll is generally heated, to soften the fibers and facilitate fusion. The surface temperature of the roll is preferably higher than the softening temperature of the fibers (or in the case of bicomponent fibers, the sheath material), but low enough so that the fibers and carrier are not damaged. For example, for a bicomponent fiber with a sheath material that softens at 240° F., 300° F. would be a suitable roll temperature. It may be desirable to bring the loop material into contact with the embossing roll prior to the nip, to increase the dwell time at the elevated roll temperature. This may be accomplished, for example, by adding an idler roll.

The dimensions of the ribs on the embossing roll will depend on the desired dimensions of the bond lanes (discussed below in the Loop Products section). However, generally the lands (raised flat area) of the ribs should be sufficiently wide so that the ribs will crush the loop structures rather than just slipping between them. The upper limit of the width of the lands, as well as the lower limit of the spacing between ribs, will be dictated by the desired open area (area having loop structures available for engagement), in the finished product. This constraint will be discussed below.

Generally the backing roll that opposes the embossing roll should be of a rigid material, such as stainless steel. If the backing roll is formed of a compliant material the ribs will tend to corrugate the loop material which is generally undesirable.

Final Processing and Other Options

The embossed web then moves through a third accumulator 90, past a metal detector 106 that checks for any broken needles or other metal debris, and then is slit and spooled for storage or shipment. During slitting, edges may be trimmed and removed, as can any undesired carrier sheet overlap region necessitated by using multiple parallel strips of carrier sheet.

Referring to FIG. 5, in an alternative lamination step a powdered binder 46 is deposited over the fiber side of the needle-punched film and then fused to the film by roll 28 or a flatbed laminator. For example, a polyethylene powder with a nominal particle size of about 20 microns can be sprinkled over the fiber-layered polyethylene film in a distribution of only about 0.5 ounces per square yard (17 grams per square meter). Such powder is available in either a ground, irregular shape or a generally spherical form from Equistar Chemicals LP in Houston, Tex. Preferably, the powder form and particle size are selected to enable the powder to sift into interstices between the fibers and contact the underlying film. It is also preferable, for many applications, that the powder be of a material with a lower melt temperature than the loop fibers, such that during bonding the fibers remain generally intact and the powder binder fuses to either the fibers or the carrier web. In either case, the powder acts to mechanically bind the fibers to the film in the vicinity of the supporting pins and anchor the loop structures. In sufficient quantity, powder 46 can also form at least a partial backing in the finished loop product, for permanently bonding the loop material onto a compatible substrate. Other powder materials, such as polypropylene or an EVA resin, may also be employed for this purpose, with appropriate carrier web materials, as can mixtures of different powders.

Loop Products

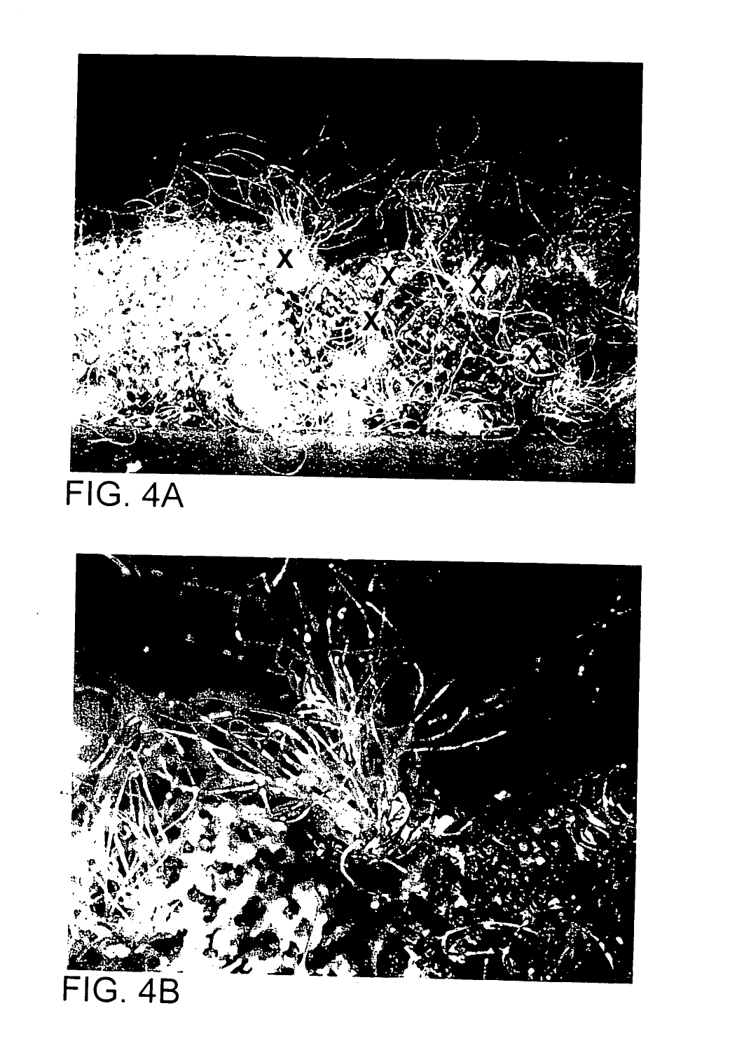

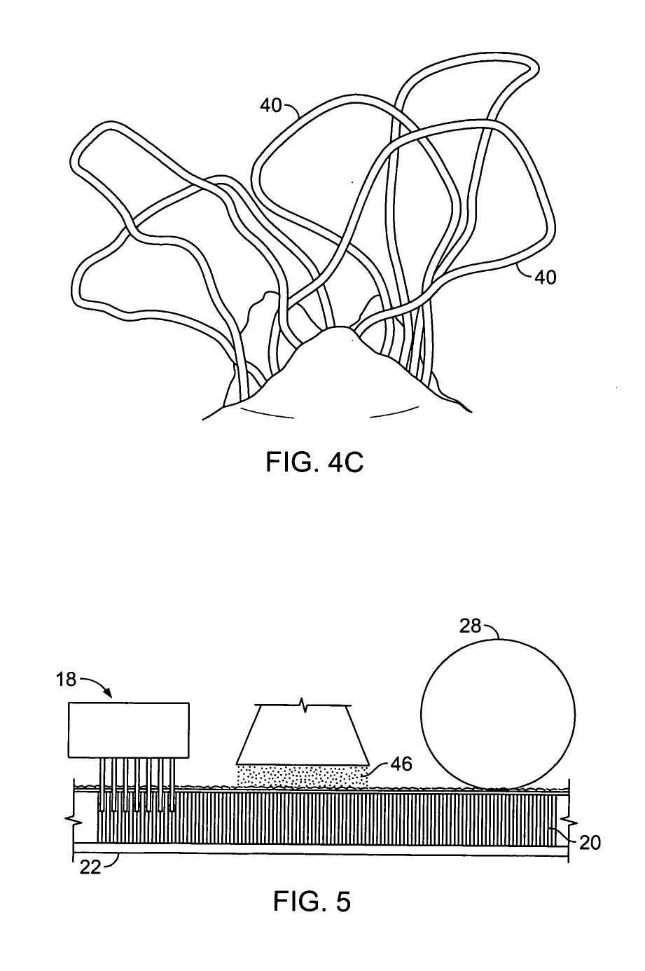

FIG. 8 shows a finished loop product, as seen from the loop side, embossed with bond lanes 58. Between bond lanes 58 are unbonded areas 59 which carry many loop structures, exposed for engagement with male fastener elements. The loop structures will be discussed below with reference to FIGS. 4-4C.

The positioning and dimensions of the bond lanes are selected to provide the loop product with a preferred balance of physical properties and performance characteristics. In some implementations, the width ‘W’ or spacing between adjacent bond lanes 58 (FIG. 8), measured from the center of one lane to the center of the adjacent lane, is about 3 to about 6 millimeters, while the thickness ‘T’ of each lane (FIG. 8A), measured from one edge of the bond area to the other, is about 1 to about 1.5 millimeter. The thickness of the lanes substantially corresponds to the width of the lands on the embossing roll, while the spacing between the lanes corresponds to the spacing between ribs. The bonded lanes may cover about 15 to 50 percent of the total area of the product, with open areas, having loop structures exposed for engagement, covering the remaining area (about 50 to 85 percent). If it is desired that the loop material have very high tear strength and shear strength, but lower engagement strengths (as measured by peel strength) are acceptable, a percent bonded area at the high end of the above range, or even higher, may be desirable. On the other hand, if engagement strength is of paramount importance, lower percent bonded areas will generally be preferred. Preferred lane width and spacing for a particular application will depend on the type of carrier film, the fiber characteristics, the loop density and loop height, and may be determined, for example, by trial and error. It is generally preferred that the bond lanes be longitudinally continuous, as shown, and that the bond lanes extend in the cross-machine direction.

The embossed loop products exhibit very good strength, even with relatively thin carrier sheets. For example, using a 0.0005 inch thick polypropylene carrier, 3 denier fibers, a punch density of 80 punches/cm2 and a penetration depth of 5 mm, embossed loop products will generally exhibit the following properties:

Tensile Breaking Strength=900 to 1350 grams/inch

Shear Strength (ASTM D 5169-91)=3500 to 4500 grams/inch

Peel Strength (ASTM D 5170-91)=350 to 600 grams/inch.

The following is a discussion of the loop structures and their properties.

FIG. 4 is an enlarged view of a loop structure 48 containing multiple loops 40 extending from a common trunk 43 through a hole in film 14, as formed by the above-described method. As shown, loops 40 stand proud of the underlying film, available for engagement with a mating hook product, due at least in part to the vertical stiffness of trunk 43 of each formation, which is provided both by the constriction of the film material about the hole and the anchoring of the fibers to each other and the film. This vertical stiffness acts to resist permanent crushing or flattening of the loop structures, which can occur when the loop material is spooled or when the finished product to which the loop material is later joined is compressed for packaging. Resiliency of the trunk 43, especially at its juncture with the base, enables structures 48 that have been “toppled” by heavy crush loads to right themselves when the load is removed. The various loops 40 of formation 48 extend to different heights from the film, which is also believed to promote fastener performance. Because each formation 48 is formed at a site of a penetration of film 14 during needling, the density and location of the individual structures are very controllable. Preferably, there is sufficient distance between adjacent structures so as to enable good penetration of the field of formations by a field of mating male fastener elements (not shown). Each of the loops 40 is of a staple fiber whose ends are disposed on the opposite side of the carrier sheet, such that the loops are each structurally capable of hook engagement. One of the loops 40 in this view is shown as being of a bicomponent fiber 41. The material of the high-tenacity fibers may be selected to be of a resin with a higher melt temperature than the film. After laminating, the fibers become permanently bonded together, and, if compatible with the film, to the film, at discrete points 42 corresponding to the distal ends of bristles 20.

Because of the relatively low amount of fibers remaining in the mat, together with the thinness of the carrier sheet and any applied backing layer, mat 108 can have a thickness “tₘ” of only about 0.008 inch (0.2 millimeters) or less, preferably less than about 0.005 inch, and even as low as about 0.001 inch (0.025 millimeter) in some cases. The carrier film 14 has a thickness of less than about 0.002 inch (0.05 millimeter), preferably less than about 0.001 inch (0.025 millimeter) and even more preferably about 0.0005 inch (0.013 millimeter). The finished loop product 30 has an overall thickness “T” of less than about 0.15 inch (3.7 millimeters), preferably less than about 0.1 inch (2.5 millimeters), and in some cases less than about 0.05 inch (1.3 millimeter). The overall weight of the loop fastener product, including carrier sheet, fibers and fused binder (an optional component, discussed below), is preferably less than about 5 ounces per square yard (167 grams per square meter). For some applications, the overall weight is less than about 2 ounces per square yard (67 grams per square meter), or in one example, about 1.35 ounces per square yard (46 grams per square meter).

FIG. 4A is an enlarged photograph of a loop product formed by needling fibers through a film with fork needles. The view is taken toward a folded edge of the product, so as to spread out the loop structures for increased visibility. Five of the loop structures shown in the photograph have been marked with an ‘X’. The surface of the film is clearly visible between the loop structures, each of which contains many individual loops emanating from a common trunk, as shown in FIG. 4B, an enlarged view of a single one of the loop structures. In FIG. 4B, light is clearly seen reflected at the base of the loop structure from film that has been raised about the hole during piercing, and that subsequently bears against the loop fibers in the hole, stiffening the trunk of the loop structure. An outline of the raised portion of film is shown on the photograph.

Fork needles tend to produce the single-trunk structures as shown in FIG. 4, which we call ‘loop trees.’ Crown needles, by contrast, tend to create more of a ‘loop bush’ structure, as illustrated in FIG. 4C, particularly in film carrier sheets. As the barbs of crown needles go through the film, they are more likely to tear the film, perhaps due to increased notch sensitivity. In polyester films, such crown needle film fracturing limits the practical maximum punch density. We have not seen such fracturing in polyethylene, but did observe barb notching. In either case, the film hole created by a crown needle doesn't tend to create the ‘turtleneck’ effect as in FIG. 4, with the result that the fibers passing through the film are not as securely supported. Well-supported loop trees are more able to resist crushing, such as from spooling of the loop material, than less-supported bush structures. Fork needles also tend to create a field of loop structures of more uniform height, whereas felting needles with multiple barb heights tend to create loop structures of more varying loop height. Furthermore, as fork needles wear, they tend to carry more, rather than fewer, loops. Teardrop needles may also be employed, and may reduce the tendency to tear off small ‘chads’ of film that can be formed by fork needles.

Materials

The above-described processes enable the cost-effective production of high volumes of loop materials with good fastening characteristics. They can also be employed to produce loop materials in which the materials of the loops, substrate and optional backing are individually selected for optimal qualities. For example, the loop fiber material can be selected to have high tenacity for fastening strength, while the substrate and/or backing material can be selected to be readily bonded to other materials without harming the loop fibers.

We have found that, using the process described above, a useful loop product may be formed with relatively little fiber 12. In one example, mat 10 has a basis weight of only about 1.0 osy (33 grams per square meter). Fibers 12 are drawn and crimped polyester fibers, 3 to 6 denier, of about a four-inch (10 centimeters) staple length, mixed with crimped bicomponent polyester fibers of 4 denier and about two-inch (5 centimeters) staple length. The ratio of fibers may be, for example, 80 percent solid polyester fiber to 20 percent bicomponent fiber. In other embodiments, the fibers may include 15 to 30 percent bicomponent fibers. The preferred ratio will depend on the composition of the fibers and the processing conditions. Generally, too little bicomponent fiber may compromise loop anchoring, due to insufficient fusing of the fibers, while too much bicomponent fiber will tend to increase cost and may result in a stiff product and/or one in which some of the loops are adhered to each other. The bicomponent fibers are core/sheath drawn fibers consisting of a polyester core and a copolyester sheath having a softening temperature of about 110 degrees Celsius, and are employed to bind the solid polyester fibers to each other, and in some cases to the carrier.

In this example, both types of fibers are of round cross-section and are crimped at about 7.5 crimps per inch (3 crimps per centimeter). Suitable polyester fibers are available from INVISTA of Wichita, Kans., (www.invista.com) under the designation Type 291. Suitable bicomponent fibers are available from INVISTA under the designation Type 254. As an alternative to round cross-section fibers, fibers of other cross-sections having angular surface aspects, e.g. fibers of pentagon or pentalobal cross-section, can enhance knot formation during needling.

Loop fibers with tenacity values of at least 2.8 grams per denier have been found to provide good closure performance, and fibers with a tenacity of at least 5 or more grams per denier (preferably even 8 or more grams per denier) are even more preferred in many instances. In general terms for a loop-limited closure, the higher the loop tenacity, the stronger the closure. The polyester fibers of mat 10 are in a drawn, molecular oriented state, having been drawn with a draw ratio of at least 2:1 (i.e., to at least twice their original length) under cooling conditions that enable molecular orientation to occur, to provide a fiber tenacity of about 4.8 grams per denier.

The loop fiber denier should be chosen with the hook size in mind, with lower denier fibers typically selected for use with smaller hooks. For low-cycle applications for use with larger hooks (and therefore preferably larger diameter loop fibers), fibers of lower tenacity or larger diameter may be employed. Once a suitable fiber denier is selected, the gauge of the forked tufting needles is selected to obtain good needling results.

For many applications, particularly products where the hook and loop components will be engaged and disengaged more than once (“cycled”), it is desirable that the loops have relatively high strength so that they do not break or tear when the fastener product is disengaged. Loop breakage causes the loop material to have a “fuzzy,” damaged appearance, and widespread breakage can deleteriously effect re-engagement of the fastener.

Loop strength is directly proportional to fiber strength, which is the product of tenacity and denier. Fibers having a fiber strength of at least 6 grams, for example at least 10 grams, provide sufficient loop strength for many applications. Where higher loop strength is required, the fiber strength may be higher, e.g., at least 15. Strengths in these ranges may be obtained by using fibers having a tenacity of about 2 to 7 grams/denier and a denier of about 1.5 to 5, e.g., 2 to 4. For example, a fiber having a tenacity of about 4 grams/denier and a denier of about 3 will have a fiber strength of about 12 grams.

Other factors that affect engagement strength and cycling are the geometry of the loop structures, the resistance of the loop structures to pull-out, and the density and uniformity of the loop structures over the surface area of the loop product. The first two of these factors are discussed above. The density and uniformity of the loop structures is determined in part by the coverage of the fibers on the carrier sheet. In other words, the coverage will affect how many of the needle penetrations will result in hook-engageable loop structures. Fiber coverage is indicative of the length of fiber per unit area of the carrier sheet, and is calculated as follows:
Fiber coverage (meters per square meter)=Basis Weight/Denier×9000
In this case, the basis weight is the weight of the fiber web. Thus, in order to obtain a relatively high fiber coverage at a low basis weight, e.g., less than 67 gsm, it is desirable to use relatively low denier (i.e., fine) fibers. However, the use of low denier fibers will require that the fibers have a higher tenacity to obtain a given fiber strength, as discussed above. Higher tenacity fibers are generally more expensive than lower tenacity fibers, so the desired strength, cost and weight characteristics of the product must be balanced to determine the appropriate basis weight, fiber tenacity and denier for a particular application. It is generally preferred that the fiber layer of the loop product have a calculated fiber coverage of at least 50,000, preferably at least 90,000, and more preferably at least 100,000.

To produce loop materials having a good balance of low cost, light weight and good performance, it is generally preferred that the basis weight of the fiber web be less than 70 gsm, e.g., 33 to 67 gsm, and the coverage be about 50,000 to 200,000.

Various synthetic or natural fibers may be employed. In some applications, wool and cotton may provide sufficient fiber strength. Presently, thermoplastic staple fibers which have substantial tenacity are preferred for making thin, low-cost loop product that has good closure performance when paired with very small molded hooks. For example, polyolefins (e.g., polypropylene or polyethylene), polyesters (e.g., polyethylene terephthalate), polyamides (e.g., nylon), acrylics and mixtures, alloys, copolymers and co-extrusions thereof are suitable. Polyester is presently preferred. Fibers having high tenacity and high melt temperature may be mixed with fibers of a lower melt temperature resin. For a product having some electrical conductivity, a small percentage of metal fibers may be added. For instance, loop products of up to about 5 to 10 percent fine metal fiber, for example, may be advantageously employed for grounding or other electrical applications. Suitable conductive synthetic fibers include silver plated polyamides, such as those commercially available from J.L. Corp., Greenville, S.C., under the tradename SHIELDEX.

In one example, mat 10 is laid upon a blown polyethylene film 14, such as is available for bag-making and other packaging applications. Film 14 has a thickness of about 0.002 inch (0.05 millimeter). Even thinner films may be employed, with good results. Other suitable films include polyesters, polypropylenes, EVA, and their copolymers. Biodegradeable films may also be used, e.g., those commercially available from Huhtamaki, Willard, Ohio. Other carrier web materials may be substituted for film 14 for particular applications. For example, fibers may be needle-punched into paper, scrim, or fabrics such as non-woven, woven or knit materials, for example lightweight cotton sheets. If paper is used, it may be pre-pasted with an adhesive on the fiber side to help bond the fibers and/or a backing layer to the paper.

The materials of the loop product can also be selected for other desired properties. In one case the loop fibers, carrier web and backing are all formed of polypropylene, making the finished loop product readily recyclable. In another example, the loop fibers, carrier web and backing are all of a biodegradable material, such that the finished loop product is more environmentally friendly. High tenacity fibers of biodegradable polylactic acid are available, for example, from Cargill Dow LLC under the trade name NATUREWORKS. In another example, carbon fibers are needle-punched into a KEVLAR film and bonded with silicone or other high temperature adhesive to produce a loop material with excellent fire resistance.

Polymer backing layers or binders may be selected from among suitable polyethylenes, polyesters, EVA, polypropylenes, and their co-polymers. Paper, fabric or even metal may be used. The binder may be applied in liquid or powder form, and may even be pre-coated on the fiber side of the carrier web before the fibers are applied. In many cases, a separate binder or backing layer is not required, such as for low cycle applications in disposable personal care products, such as diapers.

A pre-printed film or paper may be employed as the carrier web to provide graphic images visible from the loop side of the finished product. The small bonding spots and the low density of fiber remaining in the mat generally do not significantly detract from the visibility of the image. Thus, graphic images printed on the back side of the carrier film (opposite the loop side) are generally clearly visible through the loops. Printing on the back side of the film causes the ink to be encapsulated by fibers remaining on the back side of the film, to avoid ink wear. This can be advantageous, for example, for loop materials to be used on children's products, such as disposable diapers. In such cases, child-friendly graphic images can be provided on the loop material that is permanently bonded across the front of the diaper chassis to form an engagement zone for the diaper tabs. The image can be pre-printed on either surface of an otherwise transparent carrier film.

### EXAMPLES

In one test, a blend of 80% 3 denier, 4 inch long crimped polyester fibers (Type 291, Invista) and 20% 4 denier, 2 inch long bicomponent fibers (Type 254, Invista) was carded and laid over an 0.00075 inch (0.0188 millimeter) thick sheet of blown polypropylene film in a layer having a basis weight of about 1.0 ounce per square yard (33 grams per square meter). The fiber-covered film was then needled with 40 gauge 20 tufting needles, from the fiber side, at a needling density of 80 punches per square centimeter, and a penetration depth of 5.0 millimeters. The needled web was then embossed with a rib pattern of ribs extending in the cross machine direction, spaced such that T=0.050 inch (1.25 mm) and W=0.175 inch (4.38 mm) and the web includes about 70% open area (referring to the dimensions discussed above with reference to FIGS. 8-8A.

Mated with a molded hook product with CFM-108-1004 hooks in a density of about 200 hooks per square centimeter from Velcro USA in Manchester, N.H., the loops achieved an average peel of about 430 grams per inch (170 grams per centimeter), as tested according to ASTM D 5170-91. Mated with this same hook product, the loop material achieved an average shear of about 4,000 grams per square inch (635 grams per square centimeter), as tested according to ASTM D 5169-91. Tested against a CFM-97-1048 palm tree hook from Velcro USA, the loop material achieved roughly 275 grams per inch (108 grams per centimeter) of peel and 4,100 grams per square inch (635 grams per square centimeter) of shear.

A number of embodiments of the invention have been described. Nevertheless, it will be understood that various modifications may be made without departing from the spirit and scope of the invention. Accordingly, other embodiments are within the scope of the following claims.

What is claimed is:

1. A loop fastener product comprising
a generally planar nonwoven base of fibers, and
a field of loop structures extending from the generally planar nonwoven base of fibers, the field comprising
generally parallel engageable bands in which the loop structures are exposed on a front surface of the nonwoven base for releasable engagement by hooks; and
generally parallel bond area bands, separating the bands of loop structures, in which a major proportion of the loop structures are bonded together in the plane of the nonwoven base.

2. The loop fastener product of claim 1 further comprising a substrate disposed within the nonwoven base.

3. The product of claim 2 wherein the fibers extend through a front surface of the substrate to form the loop structures.

4. The product of claim 3 wherein the fibers are anchored at a back surface of the substrate.

5. The product of claim 1 wherein the fibers include bicomponent fibers.

6. The product of claim 5 wherein the fibers are bonded together by material of sheaths of the bicomponent fibers.

7. The product of claim 1 wherein the spacing between adjacent bond area bands, measured from the center of one band to the center of an adjacent band, is about 3 to about 6 millimeters.

8. The product of claim 1 wherein the thickness of each bond area band, measured from one edge of the bond area band to the other, is about 1 to about 1.5 millimeter.

9. The product of claim 1 wherein the bond area bands cover about 15 to 50 percent of the total area of the product.

10. The product of claim 1 wherein the bond area bands are longitudinally continuous.

11. A method of forming a loop fastener product, the method comprising
forming a field of loop structures extending upwardly from a front surface of a generally planar nonwoven base and exposed for releasable engagement with hooks; and then
embossing the front surface of the nonwoven base to bond the loop structures to each other in generally parallel bond area bands, in which the loop structures extend generally in the plane of the nonwoven base and are substantially unavailable for engagement, while leaving engageable bands, between the bond area bands, in which loop structures remain available for engagement.

12. The method of claim 11 wherein the forming step comprises needling a plurality of staple fibers through a carrier sheet.

13. The method of claim 12 wherein the forming step further comprises applying heat and pressure to the needled carrier, in a manner which fuses fibers to a back surface of the carrier, thereby forming a composite.

14. The method of claim 13 comprising, while applying the heat and pressure, protecting the loop structures on the front side of the substrate from application of the pressure.

15. The method of claim 11 wherein the fibers comprise bicomponent core-sheath fibers with sheaths of material having a lower melting point than their cores.

16. The method of claim 12 wherein the carrier sheet comprises a polymer film.

17. The method of claim 11 wherein the embossing step comprises passing the nonwoven base through a nip such that the front surface contacts an embossing roll having a plurality of embossing ribs.

18. The method of claim 17 wherein the embossing ribs extend axially.

19. The method of claim 11 wherein the embossing step comprises forming the bond area bands in a cross-machine direction.

20. The method of claim 17 wherein the embossing step is conducted at a nip pressure of less than about 80 pli (pounds/linear inch).

21. The method of claim 20 wherein the embossing step is conducted at a nip pressure of from about 40 to about 60 pli.
